(19) United States
(12) Patent Application Publication
(10) Pub. No.: US 2015/0176265 A1
(43) Pub. Date: Jun. 25, 2015

(54) FILTER FOR POLLUTED WATER

(71) Applicant: Leo Crasti, Kirribilli NSW (AU)

(72) Inventor: Leo Crasti, Kirribilli NSW (AU)

(21) Appl. No.: 14/412,160

(22) PCT Filed: Jul. 2, 2013
(86) PCT No.: PCT/AU2013/000719

§ 371 Date: Dec. 30, 2014

(30) Foreign Application Priority Data
Jul. 2, 2012 (AU) 2012902814

(51) Int. Cl. E03F 5/14; C02F 9/00

(52) U.S. Cl. CPC E03F 5/14; C02F 9/00; C02F 1/004

(57) ABSTRACT

An apparatus for filtering polluted water in drainage systems. The apparatus comprising a housing with a collection chamber disposed in the lower portion thereof. A primary filtration assembly disposed within the housing and having an inner cavity surrounded by opposed first and second ends and by two spaced apart walls, and an open bottom allowing the inner cavity to be in communication with the collection chamber. An inlet is disposed at or near the first end for the water to enter the collection chamber and a filter screen is disposed in the sides through which the water exits the collection chamber. A deflector is disposed at or near the second end of the collection chamber to deflect downwardly the water flowing towards it. The water exiting the inner cavity passes through a separate outer cavity in an upward direction to an outlet, the outer cavity formed between the filter screen, a bottom floor and an external wall of the primary filtration assembly.

### TECHNICAL FIELD

The present invention relates to a filtration apparatus for water drainage systems, and in particular to a system including a secondary filtration apparatus disposed downstream of a primary filtration apparatus for filtering polluted stormwater in drainage systems.

### BACKGROUND

For environmental reasons, it is becoming increasingly necessary to filter or trap pollutants from water collected by drainage systems to prevent these pollutants from being discharged into bays, rivers, creeks, or other environmentally sensitive areas. This is particularly the case for stormwater drainage systems, in which water run-off from streets, roof areas, pathways, etc collects trash, debris, and other waste with it before it runs into a water way. In recent times the filtration and trapping of pollutants has become important, as “stormwater harvesting” has become a viable way of sustaining water resources. In some areas, government regulations now mandate that in new developments stormwater filtration must be provided. There is also often a need to filter pollution from water in industrial systems.

Pollutants in stormwater fall into a number of categories. There are larger solid pollutants, known as gross pollutants, fine solid pollutants, and liquid pollutants. Solid pollutants can be further categorised by their relative density to water. Solid pollutants having a relative density of less than 1, such as twigs, closed containers, etc, are buoyant pollutants that float on the water. Solid pollutants with a relative density of between 1 and 1.5 are considered to be low density pollutants, and this includes most plastics. Solid pollutants with a relative density higher than 1.5 are considered to be high density pollutants, and this includes dense sediment.

Whilst dense sediments such as clay particles are part of the environment, they are contributors to pollution. It has recently become understood that chemicals become attached to clay particles, which then cause aggregation and storage of chemicals in sediment beds. High density pollutants tend to sink faster than low density pollutants. Liquid pollutants include floating liquids having a relative density of less than 1, such as oils. Scum is also a pollutant that floats on the water and may include mixtures of liquid and fine particles.

Various stormwater filters are known and are in use. They are often referred to as “gross pollutant traps” or “solid pollutant filters”. They are typically installed in-ground with their top exposed for access, and are connected in-line with a stormwater pipe. Prior art stormwater filters employ various methods of trapping pollutants. One method is to use filter screens to trap solid pollutants. In typical prior art systems employing filter screens, the water flows directly at the screens, which reduces the efficiency of the filter screen because when the screen becomes- partially blocked it creates a high resistance to water flowing directly at it.

Typically, prior art filters employing filter screens also include a means for water to bypass the screens if they become blocked or the flow through the filter is excessive (such as in heavy storms). An example of a prior art stormwater filter with filter screens and a bypass system is disclosed in WO 98/17875 (Ecosol Pty Ltd). The bypass system in this filter is a barrier that normally directs polluted water through the filter, but allows overflow to bypass it. Another prior art arrangement uses a bypass system comprising a floating or otherwise movable boom. Bypass systems are typically necessary where filter screens are employed, but it is desirable for a stormwater filter to minimise the amount of water that bypasses the filter screens because the bypass water carries pollutants with it.

An alternative type of stormwater filter utilizes cyclonic motion about a vertical axis. One example is the Rocla CDS™ unit by Rocla Pty Ltd which utilises the energy of the inflow to create a a vortex flow regime within the screening chamber. Another example of this type of filter is sold by Humes Water Solutions under the brand Humeceptor™. A disadvantage of this latter stormwater filter is that a deep, costly excavation is required to install it and collected pollutants are deposited deep in the filter, which can be difficult to remove. Also, the capture volume of such a filter is limited.

Another disadvantage of typical prior art gross pollutant traps is that they do not efficiently capture oil or scum in the polluted water. Also, access to clean or replace the filter screens, or to remove collected solid waste, is often difficult in prior art filters due to the nature of their design. Also, the design of some prior art filters is such that collected pollutants build up and block filter access. Furthermore, some prior art filters have many components constructed from steel, which results in a relatively short service life unless they are constructed from expensive corrosion resistant steels.

An apparatus for filtering polluted water in drainage systems that addresses at least some of the disadvantages of the abovementioned prior art is disclosed in our. International Patent Publication no. WO 2012/045120 entitled “Filter for polluted water”. This apparatus utilises a tumbling action to capture hydrocarbons, trap buoyant trash and place contaminants in a collection chamber for ease of removal at a later stage. Whilst such apparatus is more effective than earlier prior art at treating stormwater flow, it would be beneficial to further treat water that passes through such a “primary filtration apparatus”, and provide a better way of removing particulate matter. Whilst it is possible to provide a “secondary filtration apparatus” downstream of the primary filtration apparatus in a separate enclosure or housing, the disadvantages are that additional space is required which may not be available in certain circumstances, and where it is available additional cost is required in installing and maintaining a separate enclosure for the “secondary filtration apparatus”.

The present invention seeks to ameliorate the prior art, by providing a secondary filtration apparatus disposed downstream of the primary filtration apparatus.

The present invention seeks to ameliorate at least one of the disadvantages of the prior art.

### SUMMARY OF INVENTION

In a first aspect, the present invention consists of an apparatus for filtering polluted water in drainage systems, comprising:

a housing;

a collection chamber for collecting polluted water disposed in the lower portion of said housing;

a primary filtration assembly disposed substantially within said housing and having a first end, a second end opposite the first end, and an inner cavity surrounded by two spaced apart walls between said ends, and an open bottom allowing said inner cavity to be in communication with said collection chamber;

an inlet at or near said first end for the polluted water to enter the inner cavity of said primary filtration assembly;

at least one filter screen disposed in at least one of said walls through which said water exits the inner cavity;

a deflector disposed at or near said second end of said primary filtration assembly, said deflector being arranged to deflect downwardly said water flowing towards it so that as said water flows through said primary filtration assembly at least a portion of it tumbles about a substantially horizontal axis such that at or near the centre of said primary filtration assembly said water near the surface flows substantially towards said second end, and said water there below flows substantially towards said first end, wherein said water exiting said inner cavity passes through a separate outer cavity in an upward direction to at least one outlet, said outer cavity formed between said filter screen and a bottom floor and external wall of said primary filtration assembly.

Preferably at least one secondary filtration cartridge is disposed within said outer cavity.

Preferably said secondary filtration cartridge is provided with at least two flow paths, to allow for variable flow rates through said filter cartridge.

Preferably said secondary filter cartridge comprises layered filtration media.

Preferably said filtration media, is any one of zeolite, coir, activated carbon, bacteria or peat.

Preferably said deflector establishes a laminar flow state in the water in the vicinity of the deflector.

Preferably said inner cavity is elongate such that the distance between said first and second ends of said primary filtration assembly is greater than the distance between said walls.

Preferably said apparatus further comprising an oil separator for removing oil from said water, said oil separator being attached to or integral with said deflector.

Preferably in one embodiment the deflector comprises said oil separator, and the deflector comprises an array of spaced apart elements disposed parallel to the flow of the water past the deflector, and each element comprises an oil absorption material.

Preferably each element has a smooth front edge that faces the flow of said water towards the deflector.

Preferably in a further embodiment said oil separator and said deflector is in combination an oil pickup assembly comprising an endless belt.

Preferably said filter screen is replaceable.

Preferably said filter screen comprises at least two modular panels.

Preferably said housing has at least a portion which is substantially cylindrical.

Preferably said primary filtration assembly is substantially made from fibreglass material.

Preferably said housing is substantially made from concrete.

Preferably in one embodiment said primary filtration assembly comprises a frame in which said first end and said second are integrally formed.

Preferably said walls are slidably removable from said frame.

Preferably in another embodiment said primary filtration assembly comprises two spaced apart opposed frames, each frame associated with and supporting one of said spaced apart walls, and said first and second ends of said primary filtration assembly is provided by the inner surface of said housing.

Preferably in another embodiment said housing comprises an upper housing component connected to a lower housing component, said primary filtration assembly disposed in said upper housing component and said lower housing component comprising said collection chamber.

Preferably said lower housing component is substantially larger than said upper housing component.

Preferably in another embodiment said primary filtration assembly and said housing is rectangular.

Preferably said housing is a first enclosure in a concrete pit, and a second enclosure is disposed in said concrete pit adjacent to said first enclosure, and said second enclosure includes filtration media to. provide tertiary filtration downstream of said first enclosure.

Preferably a pump is provided to remove water from said collection chamber.

In a second aspect, the present invention consists of a method of separating stormwater contaminants by passing polluted stormwater through the inner cavity of a primary filtration assembly disposed above a collection chamber, and an open bottom in said primary filtration assembly allowing said inner cavity to be in communication with said collection chamber, said method comprising imparting a tumbling motion about a substantially horizontal axis to a portion of the water flow entering said primary filtration assembly through an inlet, such that said portion of the water flow is directed downwardly and back towards said inlet, and water exits said inner cavity through at least one filter screen in a wall of said primary filtration assembly to enter a separate outer cavity and flow in an upward direction to at least one outlet.

Preferably said outer cavity contains filtration media, so that water passing there through undergoes secondary filtration.

Preferably said collection chamber is adapted to receive high density pollutants that enter primary filtration assembly under the influence of gravity, whose size and density preclude them from passing through said filter screen.

Preferably at least a portion of said water being imparted with the tumbling motion is brought into contact with an oil separator, which separates at least a portion of oil and from said water.

### BRIEF DESCRIPTION OF DRAWINGS

FIG. 1 is a perspective view of an apparatus for filtering polluted water in accordance with a first preferred embodiment.

FIG. 1a is a cut-away perspective view of the apparatus shown in FIG. 1, with the top portion of the housing removed.

FIG. 2 is a sectional view along II-II of the apparatus shown in FIG. 1.

FIG. 2a is a similar sectional view to that shown in FIG. 2, but employing a different deflector/oil separator as an alternative embodiment.

FIG. 3 is a sectional view along III-III of the apparatus shown in FIG. 1.

FIG. 4 is a partial upper perspective view of the diverter of primary filtration assembly of the apparatus shown in FIG. 1.

FIG. 5 is an upper perspective view of the primary filtration assembly of the apparatus shown in FIG. 1.

FIG. 5a is an upper perspective view of an alternative embodiment of the primary filtration assembly.

FIG. 5b is an upper perspective view of the primary filtration assembly shown in FIG. 5a fitted to the housing.

FIG. 6 is a cutaway elevational view of an apparatus for filtering polluted water in accordance with a second embodiment.

FIG. 7 is an upper perspective view of a rectangular primary filtration assembly for use in an apparatus for filtering polluted water in accordance with a third embodiment where the housing is rectangular.

FIG. 8 is partial upper perspective view of an apparatus for filtering polluted water in accordance with a fourth embodiment.

FIG. 9 is a plan schematic of an apparatus for filtering polluted water in accordance with a sixth embodiment.

FIG. 10 shows the apparatus of FIG. 1 disposed within a larger reservoir.

### DESCRIPTION OF PREFERRED EMBODIMENTS

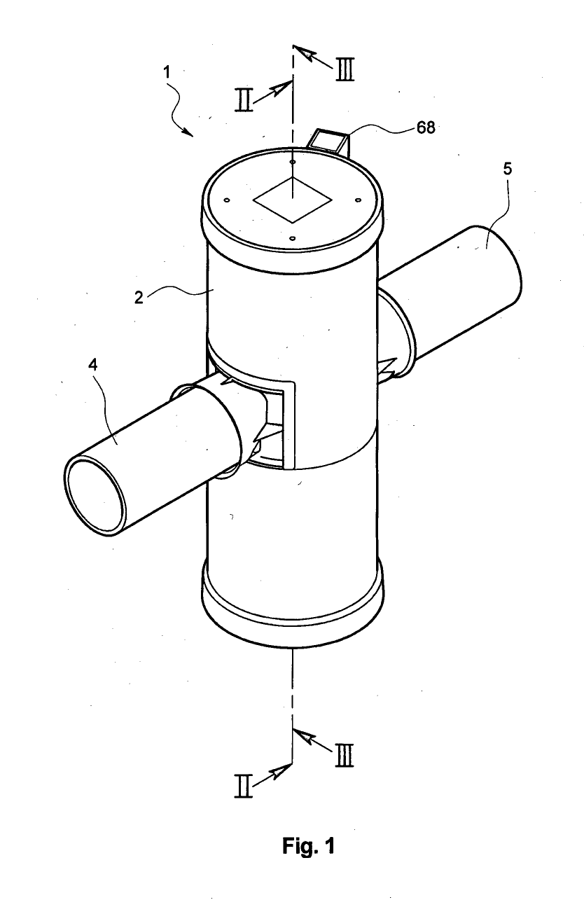

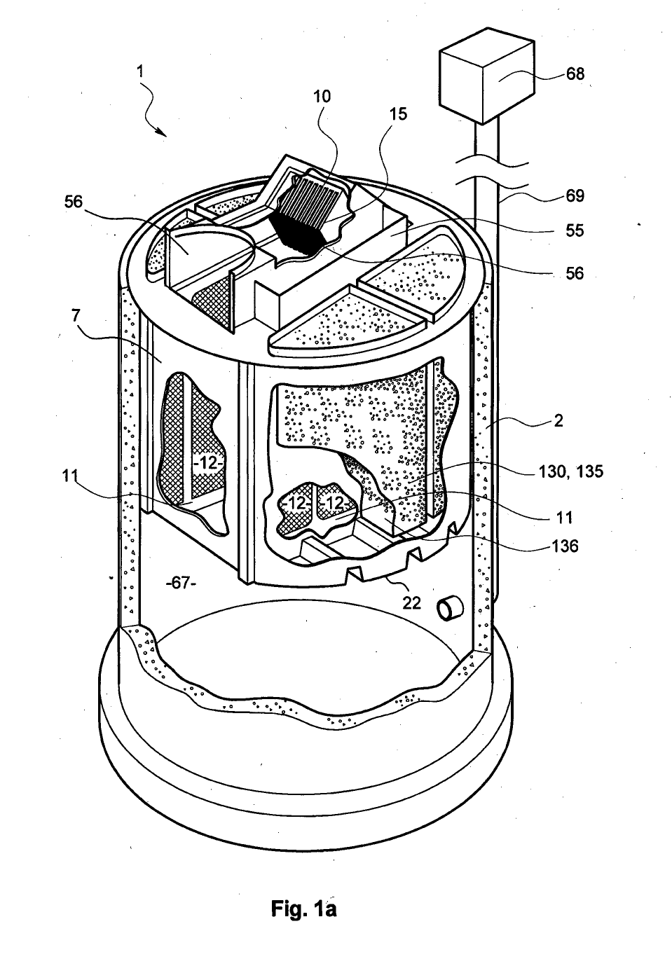

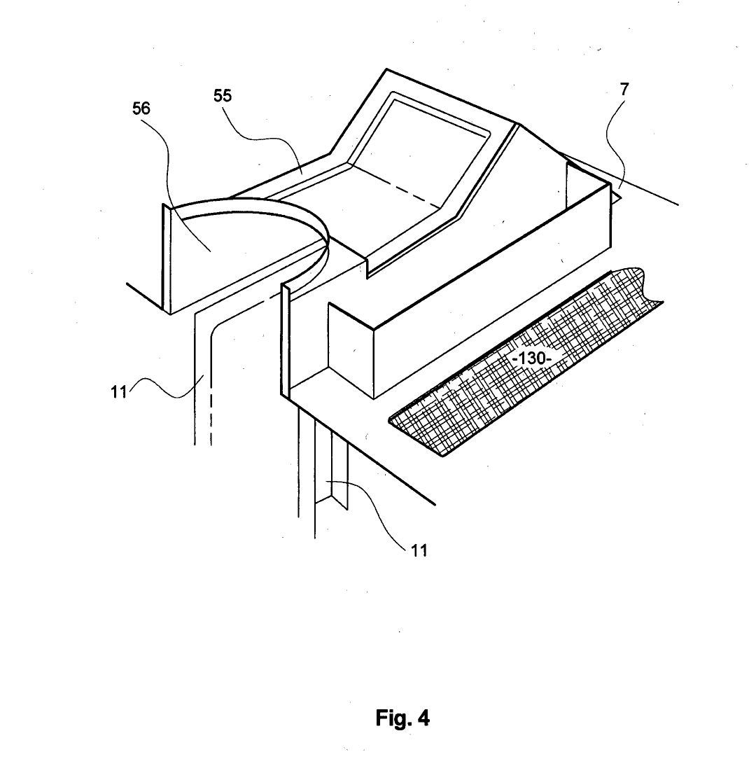

FIGS. 1, 2, 3, 4 and 5 depict a first preferred embodiment of a stormwater pollutant filter 1 in accordance with the present invention. Filter 1 is adapted to be installed in-line with a stormwater drain to separate and collect pollutants (contaminants) from stormwater passing through it. Referring to FIG. 1, filter 1 comprises a water tight, open, cylindrical shaped housing (enclosure/main pit) 2 that that houses the operating components of filter 1. In use, a housing lid (not shown) covers enclosure 2. In FIG. 1, a portion of housing 2 is cut-away, to more clearly show the location of the internal components disposed within enclosure 2.

Cylindrical housing 2 can preferably be constructed from concrete based material, preferably having a service life exceeding 100 years. Cylindrical housing 2 may preferably be made to a diameter size used for standard concrete pipes, thereby making its construction readily available from known concrete pipe manufacturers.

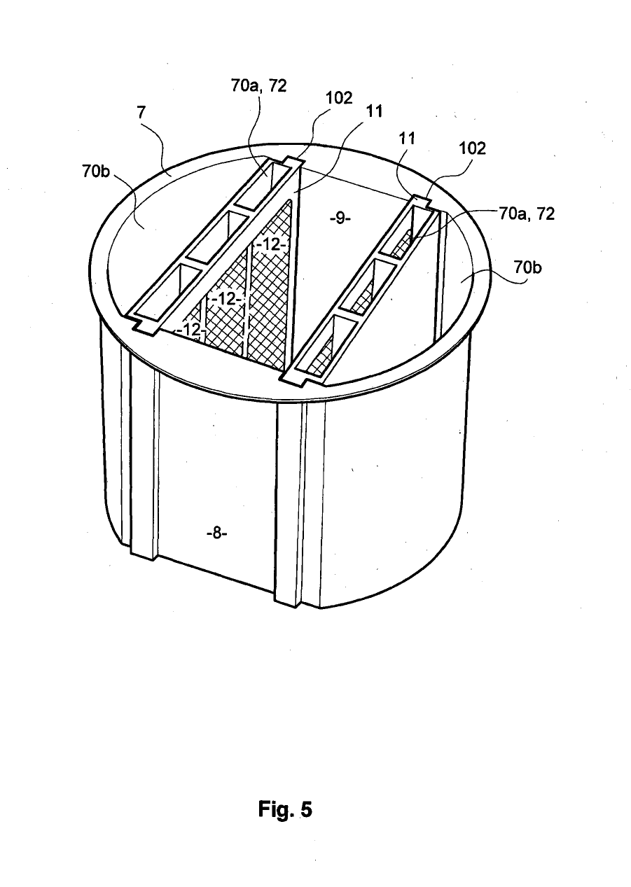

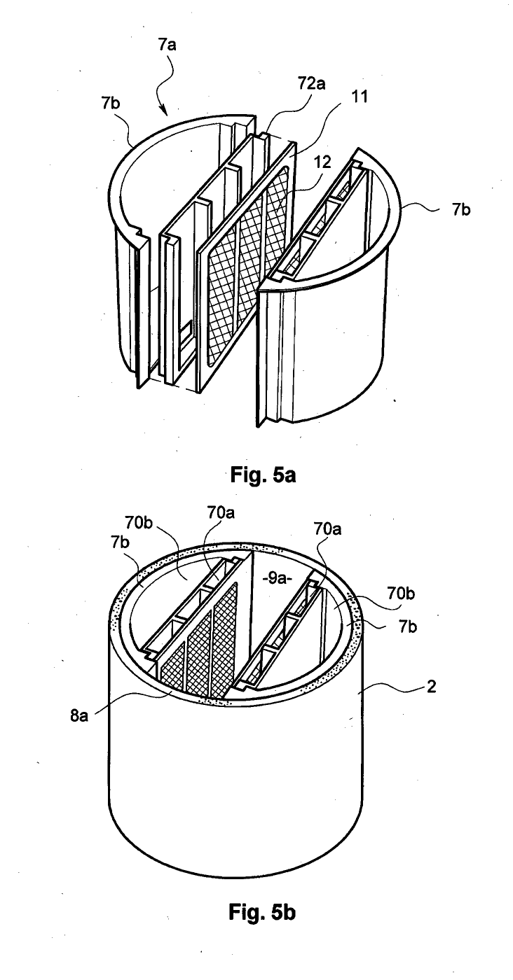

Inserted into the upper portion of housing 2 is a primary filtration assembly 7 having two walls 11, between ends 8 and 9. A plurality of vertical filter screens 12 is disposed in each wall 11 of primary filtration apparatus 7. Primary filtration assembly 7 has a diverter 55 which has an opening 56 near end 8 and supports a deflector 10 near end 9. Preferably, primary filtration assembly 7 is made of fibreglass as are its walls 11 that are adapted to slidably engage with the main frame of assembly 7 via grooves 102, best seen in FIG. 5.

Disposed below primary filtration assembly 7 in the lower portion of housing 2 is a collection chamber 67.

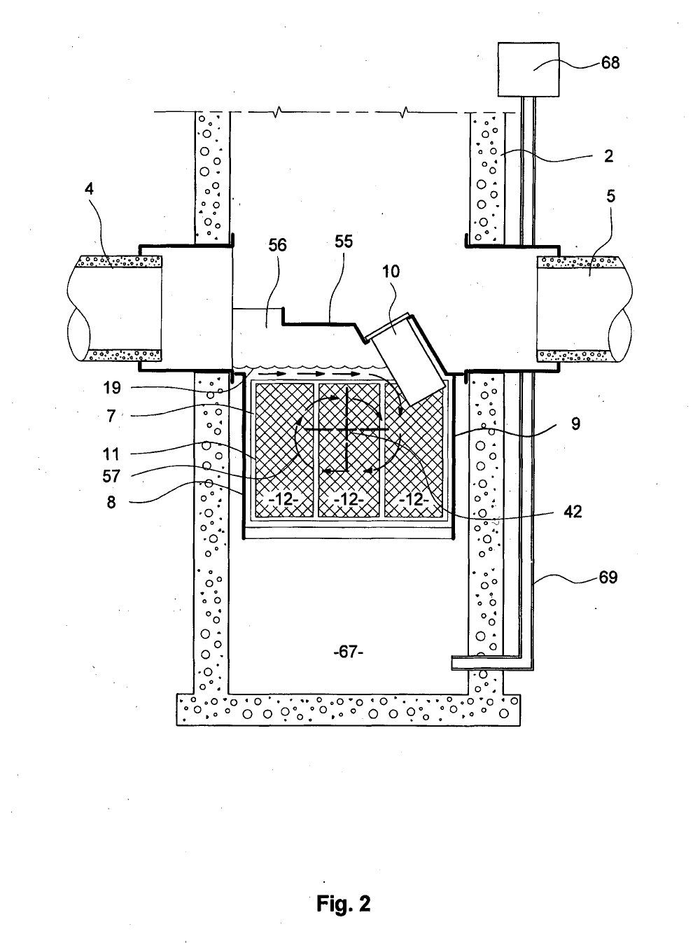

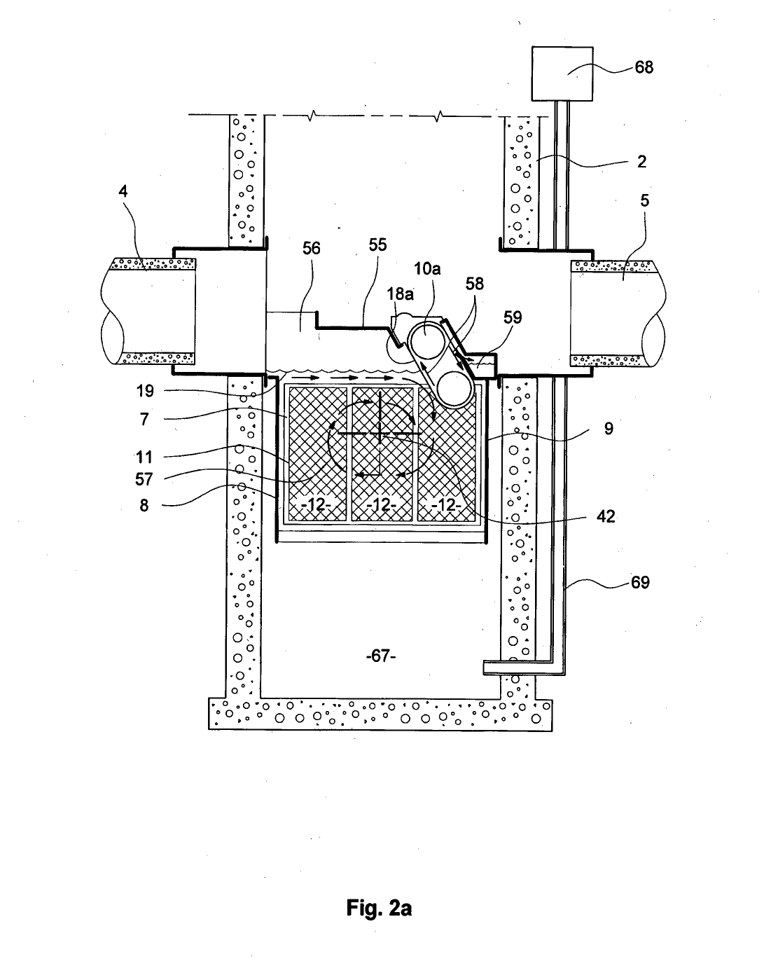

Referring to FIG. 2, polluted stormwater 19 enters filter 1 through inlet pipe 4 into housing 2, and filtered water 20 exits through an outlet pipe 5 at the opposite end of housing 2. Filter 1 is usually installed in the ground, with its housing lid (not shown) at or near ground level and exposed for access. Inlet and outlet pipes 4, 5 are typically below ground level. Inlet pipe 4 and outlet pipe 5 are at about the same height, near the top of housing 2.

Initially when filter 1 is empty, polluted water flowing into it will pass through the open bottom of primary filtration assembly 7 and fill housing 2 so that the water level raises up to level within primary filtration assembly 7.

Polluted water flowing into filter 1, through inlet pipe 4, passes through primary filtration assembly 7, having a first end 8 and a second end 9 opposite thereto. Inlet pipe 4 is at first end 8 of primary filtration assembly and opens through a wall of housing 2. At the opposite end 9 of primary filtration assembly 7 there is deflector 10, which is also an oil separator 10. The construction and function of deflector/oil separator 10 is similar to that described and shown in our International Patent Publication no. WO 2012/045120, incorporated herein by reference.

There are no openings in the end 9 for water to flow through. Primary filtration assembly 7 has two opposed walls (frames) 11, between ends 8 and 9 and bottom 22 with a central bottom opening 23 providing communication with collection chamber 67.

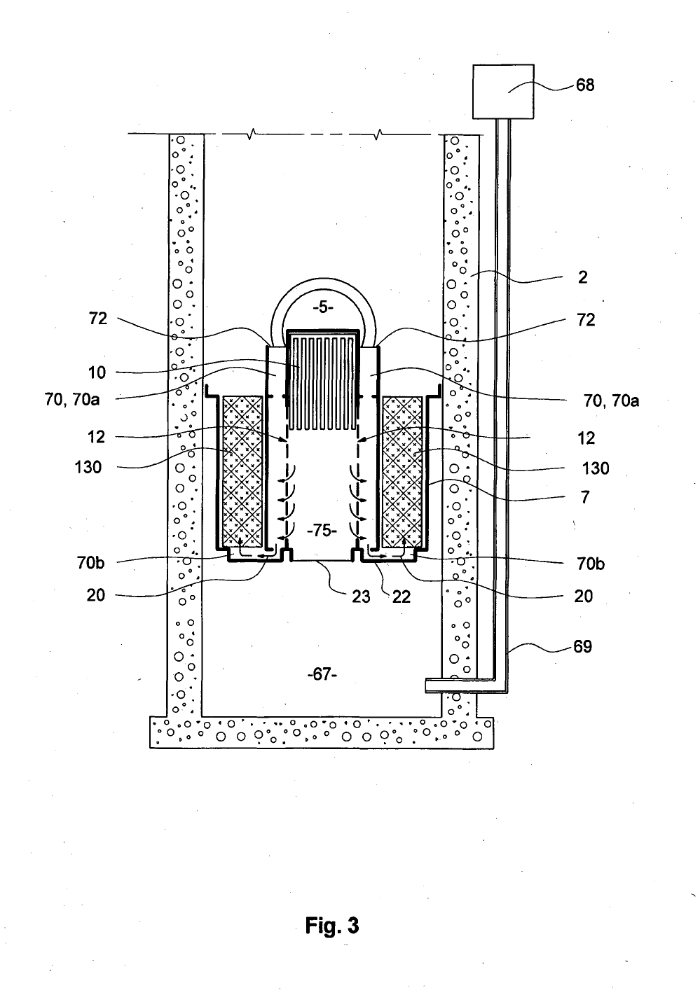

A plurality of vertical filter screens 12 is disposed in each wall 11 of primary filtration assembly 7. The filter screens 12 extend substantially from the top to the bottom of each of walls 11 of primary filtration assembly 7. The space within primary filtration assembly 7 between walls 11 and extending to its open bottom is the inner cavity 75. External of the filter screens 12 in each of walls 11 is an external cavity 70 formed in the frame structure of primary filtration assembly 7, which allows water passing through filters screens 12 to move upwardly away from primary filtration assembly 7 and into outlet 5. Each external cavity 70 has an inner bypass-path 70a directly adjacent the filter screens and a more tortuous outer path 70b starting near the bottom of filter screens 12 as best seen in FIG. 3. The operation of the bypass path 70a and outer path 70b of external cavity 70 will be described later in greater detail.

Filter screens 12 have a large area, preferably greater than twenty times the area of the diverted flow which enters primary filtration assembly 7 via opening 56. This creates a relatively slow flow velocity through screens 12, which assists in preventing blockage and reduces the stress in screens 12. This allows screen materials of a fine micron to be used to increase particle capture efficiency and reduce the size of particles that can be captured. Filter screens 12 may be constructed from various materials including stainless steel and/or plastics, depending on the water conditions, and they may have a single layer of filter material or multiple layers. In this preferred embodiment filter screens 12 are made from a suitable polyethylene.

Filter screens 12 are removable for cleaning, servicing, or to replace with a different type of filter material as conditions change or filter material technology improves. Also, different filter screens 12 may be used depending on the specific environmental needs of a particular installation, which may vary with vegetation constraints, etc. For example, in stormwater harvesting systems requiring a higher degree of filtration, finer screens 12 can be used. This ability to change screens 12 of a particular installation is an advantage over the prior art.

Collection chamber 67 is adapted to receive high density pollutants that enter primary filtration assembly 7, whose size and density preclude them from passing through filter screens 12. Such high density pollutants enter collection chamber 67 under influence of gravity via the bottom opening 23 in primary filtration assembly 7.

Each external path 70b has an entry 71 near the bottom of 22 of primary filtration assembly. The external path 70b is a semi-circular cavity which substantially extends the whole height of primary filtration assembly 7. External path 70b is adapted to receive a secondary filtration cartridge 130. In this embodiment, secondary filtration cartridge 130 is a bag filter having an external mesh bag 135 containing internally disposed layered filtration media 136.

Preferably, the filter media 36 could be any one or more organic materials in combination. Organic materials are preferred as spent media may be blended into horticultural soils where bio actions convert contaminants into bio mass and plant food. Examples of media 36 which may be used, are Zeolites (microporous aluminosilicate minerals in various grain sizes and hardness), Coir (coconut husk), Activated Carbon, Bacteria—cultured for composting use and Peat.

The operation of filter 1 will now be described. Normal flow is defined as the flow condition when all of the water passing through filter 1 passes through filter screens 12. This type of flow occurs during normal rainfall rates (i.e. not heavy storms) and when filter screens 12 are not blocked.

Referring to FIG. 2 in particular, polluted water 19 enters primary filtration assembly 7 through inlet pipe 4 and flows along its surface, towards end 9. As the flow approaches end 9, oil separator 10 deflects the flow downwards towards bottom 22 of collection chamber 22. As water 19 nears bottom 22 it then flows back towards end 8. As it approaches end 8 water flows up again, and merges with the incoming flow from inlet pipe 4. In this manner, water tumbles (swirls) about an approximately horizontal axis 42, as indicated by flow arrows 57. As this tumbling flow occurs, water 19 is drawn off from the tumbling flow and exits primary filtration assembly 7 through filter screens 12 at the same rate as the inflow through inlet pipe 4. As shown in FIG. 3, filtered water 20 that has passed through filter screens 12 then flows into external cavity 70, and in particular into external path 70b containing secondary filtration cartridge 136. The use of both the bypass path 70a and outer path 70b in effect provides a variable flow path. At “low flow” water exiting has highest concentration of contaminants and therefore flows through filter screens 12 and through secondary filtration cartridge 130 in outer path 70b. As backpressure builds up in the secondary filtration cartridge 130 water will tend to flow up bypass path 70a and exit through headers 72. This means that at low to normal flow rates through filter 1, secondary filtration cartridges 130 provide a secondary filtration to water 20 downstream of filter screens 12 of primary filtration assembly 7. However, during higher flow or where secondary filtration cartridges 130 are blocked or partially blocked causing backpressure, water 20 exiting filter screens 12 will take the path of least resistance, namely bypass path 70a.

As polluted water enters primary filtration assembly 7 through inlet pipe 4, the dissipation of energy causes high density pollutants 44 to immediately drop out and settle in the collection chamber 7.

The shape and construction of oil separator 10, establishes this beneficial tumbling flow.

Sloping front 18 of oil separator 10, and its construction as an array of spaced apart elements 15, smoothly deflects the flow downwards to establish the tumbling flow with a minimum of turbulence (i.e. substantially laminar flow).

The front edges 56 of elements 15 of oil separator 10 and its spaced apart construction establishes a laminar flow state in the vicinity of oil separator 10, by dissipating the energy of the flow in a controlled manner, such that water in the spaces between elements 15 is largely stagnant at its surface. This causes oil and scum type pollutants in water + to coalesce in the gaps between elements 15. The oil and scum is then attracted to and absorbed by oil absorption material disposed on elements 15, which retains these pollutants until absorption material is replaced, by replacing individual elements 15 or the whole of oil separator 10. As with filter screens 12, elements 15 can be changed to use different types of absorption materials.

Due to the tumbling flow state in primary filtration assembly 7, the polluted water is largely flowing across the surface of filter screens 12, with a portion of this flow being drawn off out of the tumbling flow to exit through filter screens 12. This improves the efficiency of filter screens 12 compared with prior art arrangements in which the water flows directly at screens, because the flow through filter screens 12 is relatively slow and smooth (less turbulence), and larger particles are deflected off screens 12, so they do not clog screens 12, to eventually be deposited in collection chamber 7. Filter screens 12 may be sized, as an example, to trap particles down to sizes of 25 microns. Another reason that water flowing across the surface of screens 12 improves efficiency is that particles sizes less than the aperture size of screens 12 can still be captured. The water flowing across the surface of filter screens 12, due to the tumbling flow, also washes pollutants off filter screens 12 such that the screens 12 are self-cleaning.

Some fine particles of pollutant will pass through filter screens 12. However, a proportion of these pollutants will during low and normal flow conditions will be trapped in the secondary filtration cartridges 130.

During long periods of no flow (or low flow) the water level within filter 1/housing 2 will typically fall to only submerge the lower portion of the primary filtration assembly 1 or even be lower than that in lower portion of housing 2 (ie collection chamber 67). The problem with such conditions is that when they experienced for long periods, stagnant water containing organic material can affect the efficiency of filter screens 1. Whilst tumbling flow washes pollutants off filter screens 12 such that the screens 12 are self-cleaning, when the filter 1 has been under no flow conditions for an extended period of time, a substantial amount of water would be required to pass through filter screens 12 before they achieve a desirable efficiency.

In order to minimise the risk of stagnant water causing reduced efficiency of filter screens 12, filter 1 may preferably provided with a pump 68 to lower the level of water within housing 2, when there is no flow. Pump 68 removes water from collection chamber 67 via pipe 69. Another reason that it is preferable to remove stagnant water, during no flow, is because a “wet sump” containing organic materials may create bio-digestion whereby toxicants trapped on particles are released into the sump (stagnant) water possibly creating a highly toxic liquid. Dewatering housing 2 during no flow conditions eliminates or minimizes the risk of bio-digestion, preventing environmental damage and reducing service costs as organic materials can be removed and sent to composting in preference to waste treatment.

The main advantages of the abovementioned embodiment over our own filtration apparatus of our International Patent Publication no. WO 2012/045120 is as follows.

Firstly, primary filtration assembly 7 in which the “tumbling action” is established in this embodiment, does not need to extend to the bottom of housing 2, this means that a single sized “primary filtration assembly” to suit a single diameter housing could be used, with the length of housing being altered to suit increased storage by varying the size of the storage area (collection chamber 67 disposed in the lower portion of housing 2).

Secondly, the shape and configuration of the primary filtration assembly 7 and how it is now used with housing 2, means that water passing through the filter screens 12 of primary filtration assembly can have secondary filtration applied downstream thereof, namely that provided as secondary filtration cartridges located within the housing.

Thirdly, the abovementioned embodiment has the flexibility that filter 1 can be used with or without secondary filtration cartridges.

In the abovementioned first preferred embodiment, and as previously mentioned deflector/oil separator 10 is similar to that described and shown in our International Patent Publication no. WO 2012/045120. In an alternative embodiment, as shown in FIG. 2a, a different deflector/oil separator 10a is employed. This alternative deflector/oil separator 10a, like that of the first preferred embodiment is supported by diverter 55 near end wall 9. It uses a motor driven “oil pickup assembly” employing a driven endless belt 18a which picks up oil and scum from the swirling (tumbling) water depicted by arrows 57, and moves the picked up oil/scum material in a direction shown by arrows 58. The endless belt 18a is made of (or supports) material capable of “picking up” oil, from the swirling water it comes in contact with. This picking up occurs because the oil/scum is “coalesced” or “attracted” to endless belt 18a or material supported by same. Oil/scum is removed from endless belt 18a by a wiper (or other removal device) and deposited into hydrocarbon trap 59. It should be understood that deflector/oil separator 10a is angled into the water such that it deflects the swirling water downwardly in a like manner to deflector/oil separator 10 of the first preferred embodiment.

In the abovementioned first preferred embodiment the primary filtration assembly 7 as shown in FIG. 5 has a main frame provided with grooves 102, into which walls 11/screens 12 and a header unit 72 are slidably engaged. However, it should be understood that in an alternative embodiment as shown in FIG. 5a, primary filtration assembly 7a, is made of up of two opposed “semi-cylindrical like” frames 7b, each of which are adapted to support an associated wall 11/screen 12 and header unit 72a. In this alternative embodiment, when primary filtration frames 7b, along with their associated walls 11, screens 12 and header units 72a are fitted to housing 2, the opposed inner wall surfaces of housing 2 between screens 12 act as the opposed end walls 8a, 9a of primary filtration assembly 7a, in a similar fashion to the first preferred embodiment. However, as housing 2 is cylindrical, the end walls 8a, 9a in this embodiment are curved, as shown in FIG. 5b. In this alternative embodiment, as in the first preferred embodiment a bypass path 70a and outer path 70b is provided.

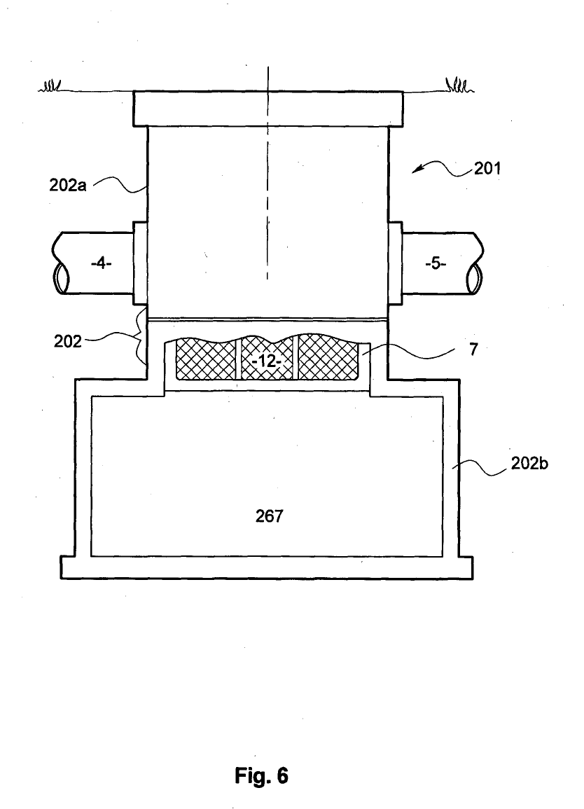

It should be understood that the present invention and its advantages could still be achieved in various other alternative embodiments. For example FIG. 6, depicts a second embodiment of a filter 201 where housing 202 is made of an upper housing component 202a and a lower housing component 202b. Upper housing component 202a houses a primary filtration assembly 7 in a similar fashion to the first embodiment, and this upper housing component 202a is connected to lower housing component 202b which acts as the collection chamber (storage area) 67. This second embodiment could be employed to suit conditions where a high concentration of collected material is expected.

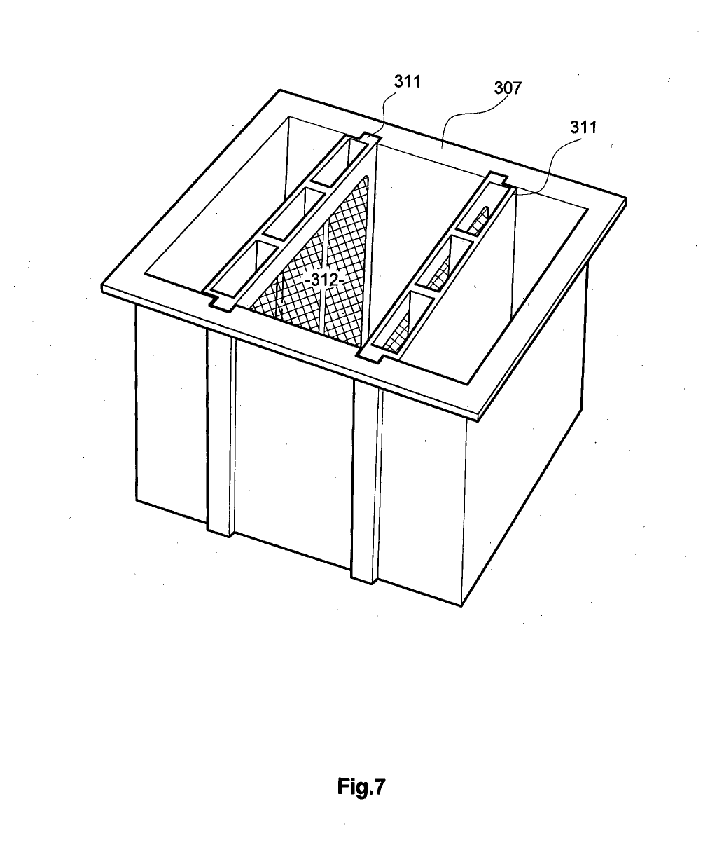

FIG. 7 depicts a primary filtration assembly 307 which is rectangular shaped but operates in a similar fashion to primary filtration assembly 7 of the first embodiment, and utilises wall 311 supporting screens 312. Primary filtration assembly 307 could be used with a rectangular housing (not shown) similar in function to housing 2 of the first embodiment.

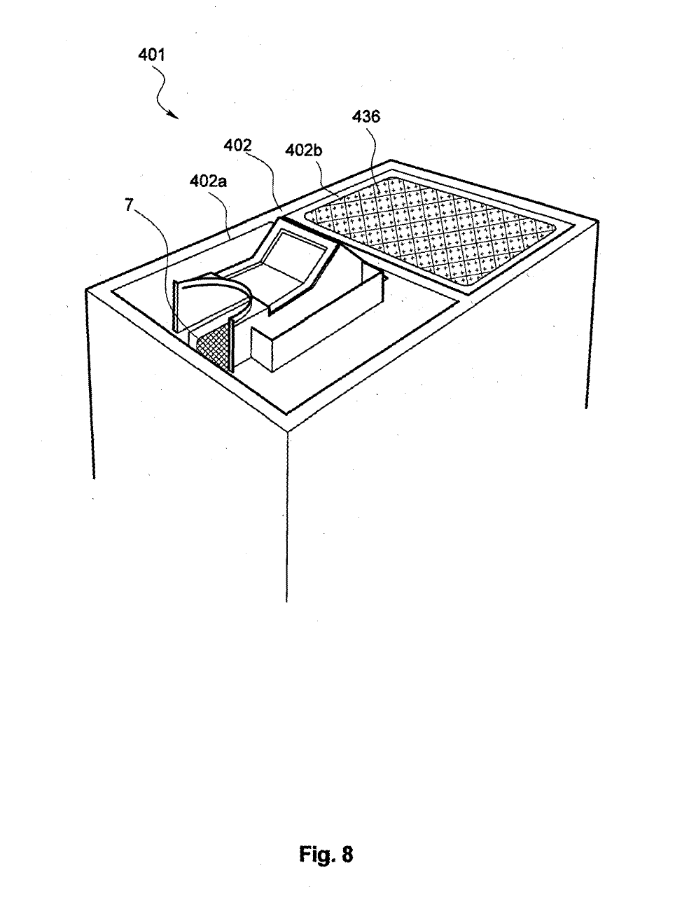

FIG. 8 depicts a fourth embodiment of a filter 401 having a large rectangular housing 402 with first and second adjacent enclosures 402a and 402b. The first enclosure has primary filtration assembly 7 disposed therein and would operate in similar fashion to the first and third embodiments, with a collection chamber (not shown) below primary filtration assembly 7 and secondary filtration cartridges (not shown). Second enclosure 402b includes filtration media 436 to provide tertiary filtration downstream of first enclosure 402a.

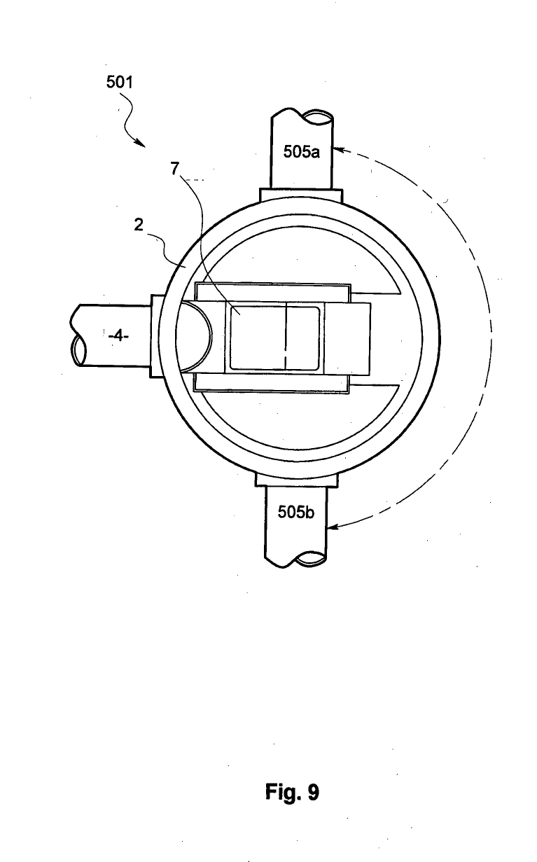

It should be understood that other variations to the abovementioned embodiments could be employed. For instance FIG. 9 shows in a fifth embodiment a variation to the first embodiment. In this variation filter 501 would be identical to the first embodiment in regards to the housing 2, inlet 4 and the internal components such as the primary filtration assembly 7 etc. However, in this embodiment the outlet 5 of the first embodiment is replaced by two side outlets 505a, 505b which are disposed for outlet flow at right angles to inlet flow.

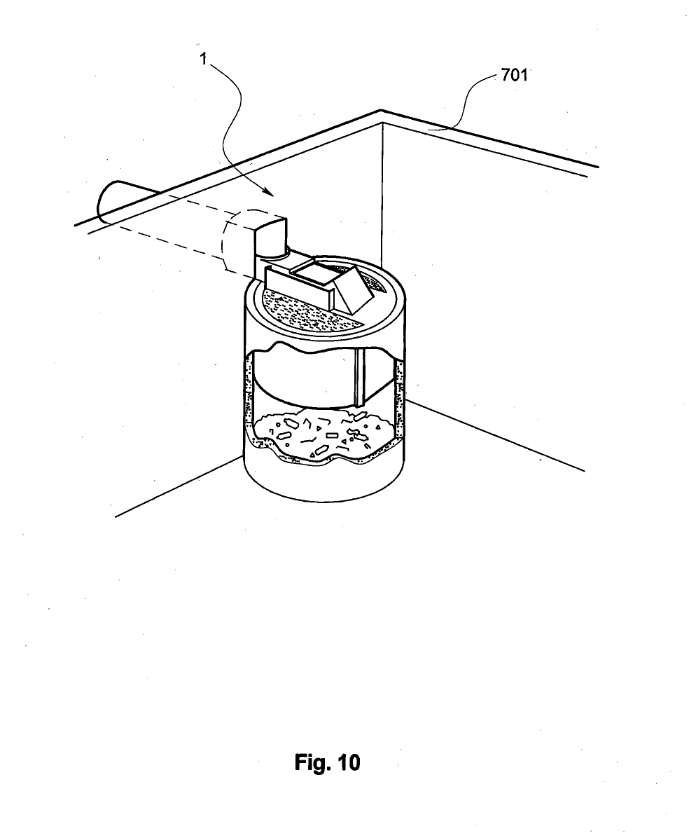

It should also be understood that a filter of the present invention could also be placed at the inflow of a larger detention tank, reservoir or water harvesting application. For example, FIG. 10 shows the first embodiment filter 1, placed in a larger reservoir 701.

Whilst the above described embodiments are directed to stormwater systems, the invention is also applicable to other drainage applications. Also, filters in accordance with the present invention may be constructed from other than concrete, or be adapted to be above ground rather than placed in the ground.

The terms “comprising” and “including” (and their grammatical variations) as used herein are used in an inclusive sense and not in the exclusive sense of “consisting only of”.

1. An apparatus for filtering polluted water in drainage systems, comprising:
a housing;
a collection chamber for collecting polluted water disposed in the lower portion of said housing;
a primary filtration assembly disposed substantially within said housing and having a first end, a second end opposite the first end, and an inner cavity surrounded by two spaced apart walls between said ends, and an open bottom allowing said inner cavity to be in communication with said collection chamber;
an inlet at or near said first end for the polluted water to enter the inner cavity of said primary filtration assembly;
at least one filter screen disposed in at least one of said walls through which said water exits the inner cavity;
a deflector disposed at or near said second end of said primary filtration assembly, said deflector being arranged to deflect downwardly said water flowing towards it so that as said water flows through said primary filtration assembly at least a portion of it tumbles about a substantially horizontal axis such that at or near the centre of said primary filtration assembly said water near the surface flows substantially towards said second end, and said water there below flows substantially towards said first end, wherein said water exiting said inner cavity passes through a separate outer cavity in an upward direction to at least one outlet, said outer cavity formed between said filter screen and a bottom floor and external wall of said primary filtration assembly.

2. The apparatus for filtering polluted water as claimed in claim 1, wherein at least one secondary filtration cartridge is disposed within said outer cavity.

3. The apparatus for filtering polluted water as claimed in claim 2, wherein said secondary filtration cartridge is provided with at least two flow paths, to allow for variable flow rates through said filter cartridge.

4. The apparatus for filtering polluted water as claimed in claim 2, wherein said secondary filter cartridge comprises layered filtration media.

5. The apparatus for filtering polluted water as claimed in claim 4, wherein said filtration media, is any one of zeolite, coir, activated carbon, bacteria or peat.

6. The apparatus for filtering polluted water as claimed in claim 1, wherein said deflector establishes a laminar flow state in the water in the vicinity of the deflector.

7. The apparatus for filtering polluted water as claimed in claim 1, wherein said inner cavity is elongate such that the distance between said first and second ends of said primary filtration assembly is greater than the distance between said walls.

8. The apparatus for filtering polluted water as claimed in claim 1, further comprising an oil separator for removing oil from said water, said oil separator being attached to or integral with said deflector.

9. The apparatus for filtering polluted water as claimed in claim 8, wherein the deflector comprises said oil separator, and the deflector comprises an array of spaced apart elements disposed parallel to the flow of the water past the deflector, and each element comprises an oil absorption material.

10. (canceled)

11. The apparatus for filtering polluted water as claimed in claim 8, wherein said oil separator and said deflector is in combination an oil pickup assembly comprising an endless belt.

12-16. (canceled)

17. The apparatus for filtering polluted water as claimed in claim 1, wherein said primary filtration assembly comprises a frame in which said first end and said second are integrally formed.

18. The apparatus for filtering polluted water as claimed in claim 17, wherein said walls are slidably removable from said frame.

19. The apparatus for filtering polluted water as claimed in claim 1, wherein said primary filtration assembly comprises two spaced apart opposed frames, each frame associated with and supporting one of said spaced apart walls, and said first and second ends of said primary filtration assembly is provided by the inner surface of said housing.

20. The apparatus for filtering polluted water as claimed in claim 1, wherein said housing comprises an upper housing component connected to a lower housing component, said primary filtration assembly disposed in said upper housing component and said lower housing component comprising said collection chamber.

21. The apparatus for filtering polluted water as claimed in claim 20, wherein said lower housing component is substantially larger than said upper housing component.

22. The apparatus for filtering polluted water as claimed in claim 1, wherein said primary filtration assembly and said housing is rectangular.

23. The apparatus for filtering polluted water as claimed in claim 2, wherein said housing is a first enclosure in a concrete pit, and a second enclosure is disposed in said concrete pit adjacent to said first enclosure, and said second enclosure includes filtration media to provide tertiary filtration downstream of said first enclosure.

24. The apparatus for filtering polluted water as claimed in claim 1, wherein a pump is provided to remove water from said collection chamber.

25. A method of separating stormwater contaminants by passing polluted stormwater through the inner cavity of a primary filtration assembly disposed above a collection chamber, and an open bottom in said primary filtration assembly allowing said inner cavity to be in communication with said collection chamber, said method comprising imparting a tumbling motion about a substantially horizontal axis to a portion of the water flow entering said primary filtration assembly through an inlet, such that said portion of the water flow is directed downwardly and back towards said inlet, and water exits said inner cavity through at least one filter screen in a wall of said primary filtration assembly to enter a separate outer cavity and flow in an upward direction to at least one outlet.

26. The method of claim 25, wherein said outer cavity contains filtration media, so that water passing there through undergoes secondary filtration.

27-28. (canceled)
